(19) United States
(12) Patent Application Publication
(10) Pub. No.: US 2019/0207232 A1
(43) Pub. Date: Jul. 4, 2019

(54) Overload Protection Device

(71) Applicant: Intelligent Energy Limited, Loughborough (GB)

(72) Inventors: Moutazbellah Khater, Loughborough (GB); Jason Roberts, Loughborough (GB)

(73) Assignee: Intelligent Energy Limited, Loughborough (GB)

(21) Appl. No.: 15/768,489

(22) PCT Filed: Oct. 6, 2016
(86) PCT No.: PCT/GB2016/053115

§ 371 Date: Apr. 13, 2018

(30) Foreign Application Priority Data
Oct. 9, 2015 (GB) 1517874.2

(51) Int. Cl. H01M 8/04223; H01M 8/04537; H01M 8/04746; H01M 8/043; H01M 8/04089; H01M 8/04007

(52) U.S. Cl. CPC H01M 8/04238; H01M 8/04567; H01M 8/04597; H01M 2250/20; H01M 8/043; H01M 8/04089; H01M 8/04037; H01M 8/04753

(57) ABSTRACT

A fuel cell system comprises an electrochemical fuel cell stack for generating electrical power. A load circuit is switchably coupled to the fuel cell stack for periodically receiving a discharge current from the fuel cell stack during an energy dissipation phase, such as an air stall operation for conditioning the fuel cell stack. A protection circuit is coupled to the load circuit, configured to monitor a cumulative energy dissipation level during an energy dissipation phase and to abort an energy dissipation phase if the cumulative energy level reaches a predetermined threshold. In this way, lower specification resistor components can be used for stack conditioning.

The present invention relates to fuel cell systems, and in particular to performance management if such fuel cell systems. In order to provide optimal performance of electrochemical fuel cell stacks, it is desirable to routinely perform stack and/or cell conditioning operations on the stack or on individual cells or groups of cells within the stack to maintain the cells in an optimally performing condition.

Although beneficial for the purpose of maintaining maximum, improved or optimal efficiency of a fuel cell stack, such performance management systems nevertheless present a considerable additional overhead on the fuel cell stack, not least in view of the additional hardware required for the fuel cell stack supporting infrastructure, with associated additional manufacturing cost and space utilisation.

Since the stack supporting infrastructure has a direct impact on important parameters such as the system cost per unit of power generation capacity, and system weight or volume per unit of power generation capacity, it is desirable to reduce this infrastructure overhead as much as practicable.

It is an object of the present invention to provide an improved system for performance management of a fuel cell or fuel cell stack.

According to one aspect, the present invention provides a fuel cell system comprising: an electrochemical fuel cell for generating electrical power; a load circuit switchably coupled to the fuel cell for periodically receiving a discharge current from the fuel cell during an energy dissipation phase; a protection circuit coupled to the load circuit, the protection circuit configured to monitor a cumulative energy dissipation level during an energy dissipation phase and to abort an energy dissipation phase if the cumulative energy level reaches a predetermined threshold.

The load circuit may comprise a resistor. The protection circuit may comprise a voltage sensor and a module configured to integrate a function of the sensed voltage during an energy dissipation phase, the protection circuit further configured to abort the energy dissipation phase if the integration reaches said predetermined threshold. The voltage sensor may be configured to sense a voltage across a resistor of the load circuit.

The protection circuit may comprise a current sensor and a module configured to integrate a function of the sensed current during an energy dissipation phase, the protection circuit further configured to abort the energy dissipation phase if the integration reaches said predetermined threshold. The current sensor may be configured to sense a current passing through a resistor of the load circuit.

The protection circuit may comprises a voltage sensor and a current sensor, and a module configured to determine said cumulative energy dissipation level in the load circuit from the sensed voltage and current during an energy dissipation phase. The voltage sensor may be configured to sense a voltage across a resistor of the load circuit and the current sensor may be configured to sense a current passing through the resistor of the load circuit.

The fuel cell system may include a system controller configured to periodically initiate an energy dissipation phase by switching the load circuit across one or more fuel cells in the fuel cell system. The system controller may be further configured to periodically shut off air flow through the one or more fuel cells during the energy dissipation phase and to restore air flow after the energy dissipation phase. The system controller may be configured to shut off air flow through the one or more fuel cells prior to the energy dissipation phase so as to allow the one or more fuel cells to reach an oxygen-starved condition prior to commencement of the energy dissipation phase. The system controller may be configured to inhibit initiation of a further energy dissipation phase for a predetermined period of time in the event of an aborted energy dissipation phase. The system controller may be configured to restrict the duration of a subsequent energy dissipation phase in the event of an aborted energy dissipation phase.

The electrochemical fuel cell may comprise a stack of series-connected fuel cells. The electrochemical fuel cell may comprise an array of parallel connected fuel cells. According to another aspect, the invention provides a protected electrical load device, the load device comprising: a load circuit for switchably coupling to a power source for periodically receiving a discharge current from the power source during an energy dissipation phase; a protection circuit coupled to the load circuit, the protection circuit configured to monitor a cumulative energy dissipation level in the load circuit during an energy dissipation phase and to abort an energy dissipation phase if the cumulative energy level reaches a predetermined threshold.

According to another aspect, the invention provides a method of operating a fuel cell system, comprising:
generating electrical power in an electrochemical fuel cell; periodically passing a discharge current from the fuel cell into a load circuit during an energy dissipation phase;
during the energy dissipation phase, monitoring cumulative energy dissipated in the load circuit; and
aborting the energy dissipation phase if the cumulative energy level exceeds a predetermined threshold.

According to another aspect, the invention provides a fuel cell system comprising:
an electrochemical fuel cell for generating electrical power;
an air stall mechanism configured to periodically inhibit air flow in a cathode flow path of the fuel cell during an air stall operation;
a load circuit switchably coupled to the fuel cell for periodically receiving a discharge current from the fuel cell during the air stall operation, the load circuit comprising at least one resistor;
wherein the electrochemical fuel cell has an air stall energy comprising the amount of energy deliverable by the fuel cell during an air stall operation, and
wherein the at least one resistor of the load circuit is selected with a short term overload rating and a continuous rating such that it operates within its short term overload rating but outside its continuous power rating when dissipating the full fuel cell air stall energy.

According to another aspect, the invention provides a method of operating a fuel cell system, comprising:
generating electrical power with an electrochemical fuel cell;
initiating an air stall within the fuel cell for an air stall period so as to starve the fuel cell cathode of oxidant, the fuel cell having an air stall energy;
dissipating the air stall energy within a load circuit switchably coupled to the fuel cell during the air stall period, the air stall energy being dissipated within one or more resistors in the load circuit such that the resistor operates outside its continuous power rating but within its short term overload rating when dissipating the air stall energy.

Embodiments of the present invention will now be described by way of example and with reference to the accompanying drawings in which:

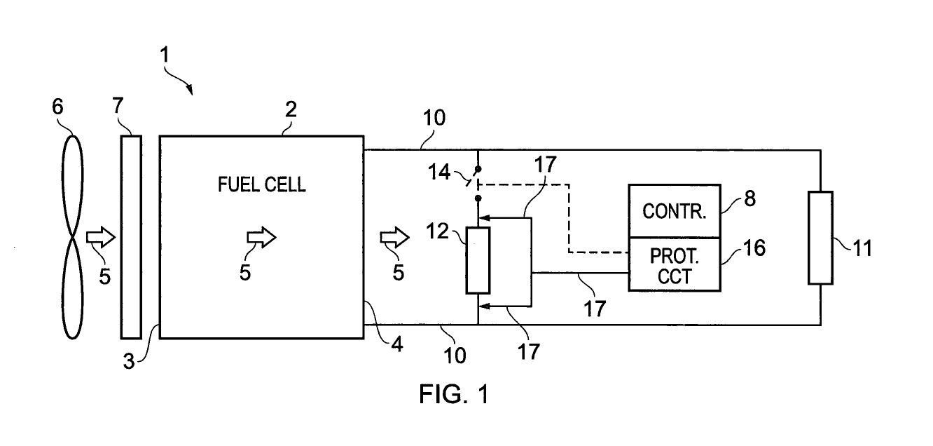

FIG. 1 shows an air cooled fuel cell system;

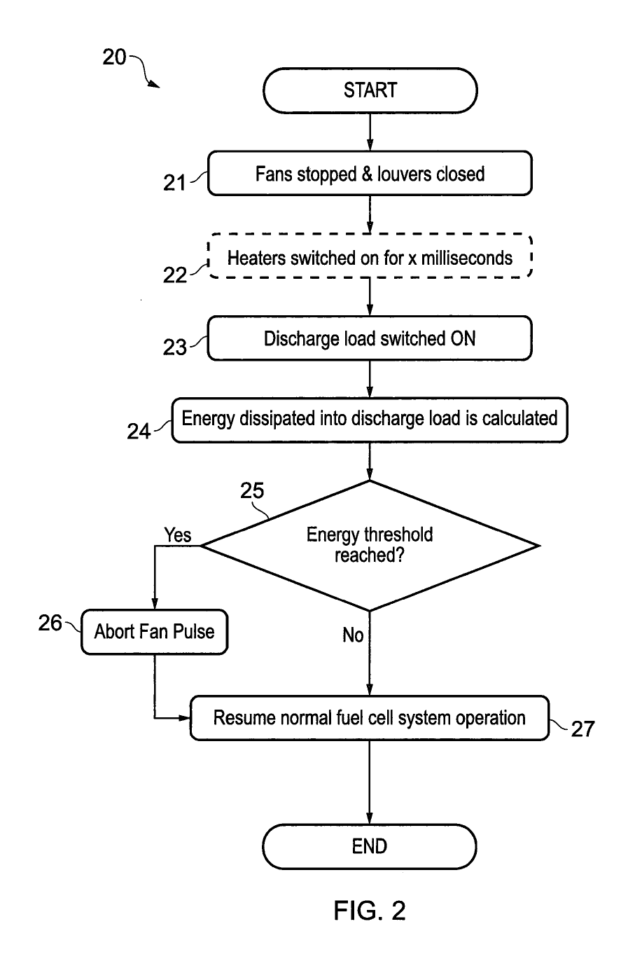

FIG. 2 shows a flow diagram of a ‘stack pulse’ or ‘air stall’ operation;

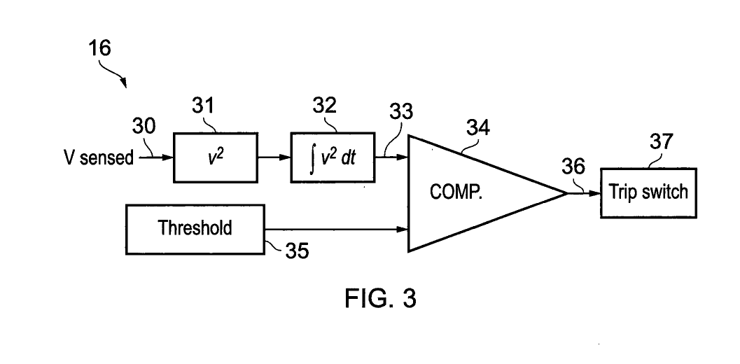

FIG. 3 shows a functional block diagram of a protection circuit;

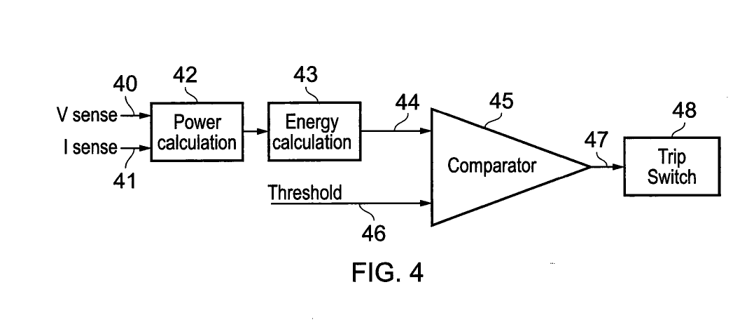

FIG. 4 shows a functional block diagram of an alternative protection circuit.

In some types of fuel cell systems, efficiency and performance of the fuel cells in the fuel cell stack can be improved by a stack conditioning operation comprising periodically starving the fuel cell stack of air and discharging the stack into a load, e.g. by drawing a high current from the air-starved fuel cells into the load. In some circumstances, it is possible to do this using an existing load device of the fuel cell system, particularly where there is flexibility in, and control over, the normal load device being supplied by the fuel cell system. In some circumstances, where multiple fuel cell stacks are servicing a normal load device, it may be possible to isolate one stack at a time and discharge the selected stack through the normal load device. This can be efficient in that power continues to be delivered during the conditioning operation. However, with this method, the output voltage range may be very large and this may require much more complexity in DC/DC voltage conversion stages between the fuel cell system and the normal load device. This in itself can result in significant increase in overhead and inefficiency introduced by increased demand on the DC/DC converter specification, as well as substantive additional cost for a higher performing DC/DC converter.

In many cases, however, freedom to control the normal load device does not exist and in order to provide a periodic current discharge phase it is necessary to provide an alternative load circuit for the fuel cell system which can be periodically applied to fuel cells in the system. This can be done by providing one or more resistors in a special load circuit which can be switchably coupled to the fuel cells for periodically receiving a high discharge current from the fuel cells during special energy dissipation phases.

In order to discharge the stack properly, a significant amount of energy has to be dissipated into power resistors. Thus, large power resistors would be required. Unfortunately, employing bulky power resistors adds significant additional volume, weight and cost to the system which may not always be possible or desirable. A solution is to employ relatively small power resistors and to deliberately overload them for a short period of time.

In air cooled fuel cell systems, one technique for conditioning fuel cell stacks comprises ‘stack pulsing’ or ‘fan pulsing’, in which air flow to the cathodes of the fuel cell stack is periodically shut off or significantly restricted to starve the cathode of oxygen and the stack is discharged at high current through load resistors, such that energy dissipation occurs during this period of air flow restriction.

Air cooled fuel cell stacks are very sensitive to cathode air flow. A small amount of air movement through a cathode air flow path is still enough for the stack to produce significant power. Therefore protecting the discharge resistors in the load circuit is highly desirable, otherwise they may be damaged during a failed stack pulse when air flow restriction was either not reduced or insufficiently reduced/restricted. Such a failed fan pulse could for example occur when stack louvres configured to block air flow do not operate correctly or fully, or when ram air is forced through the fuel cell at a higher than expected rate (e.g. past louvres), for example arising from movement of the fuel cell in a vehicle.

It is therefore desirable to ensure that stack energy and stack discharge behaviour during fan pulses is well characterised; that suitable power resistors are deployed; that a protection system is provided to protect the discharge resistors from excessive energy.

FIG. 1 shows an example of an air cooled fuel cell stack suitable for implementation of a load protection system. The fuel cell system 1 comprises an electrochemical fuel cell stack 2 of the air cooled variety in which cathode air is supplied to a cathode inlet face 3 and exhausted via a cathode outlet face 4. An air flow path 5 through the fuel cell stack 2 may be assisted during normal and/or high load operation by way of a fan 6 disposed in the air flow path 5 and adjacent to either the inlet face 3 or the outlet face 4 (as shown) of the fuel cell stack 2. A louvre, shutter or blind serving as an air stall mechanism 7 is also disposed in the air flow path 5, adjacent to either the inlet face 3 (as shown) or the outlet face 4 of the fuel cell stack. The air stall mechanism 7 may be operated to temporarily and periodically inhibit air flow through the fuel cell stack, so as to starve the cathode of oxygen. This periodic inhibition of air flow through the stack 2 may be effected by one or more of: shutting off the fan 6; closing a louvre, blind or shutter disposed in the air flow path 5 on the upstream side of the fuel cell stack (adjacent to inlet face 3) and closing a louvre, blind or shutter disposed in the air flow path 5 on the downstream side of the fuel cell stack (adjacent to outlet face 4). The air stall mechanism 7 is controllable by a controller 8 which is configured to periodically initiate an air stall operation, which may also be referred to as a “stack pulse” or “fan pulse” operation.

The fuel cell stack 2 has an electrical output indicated as output lines 10 which may, in the course of normal service of the fuel cell system 1, be used to supply a service load 11. The service load 11 may be any device or network to which the fuel cell system is coupled to supply power, such as a vehicle motor, a vehicle, a domestic or industrial power network; or an electronic device, for example. In a typical operating environment, the fuel cell stack 2 would be interfaced to a service load 11 by way of suitable control devices such as a DC/DC converter and other power/current/voltage regulation and/or protection mechanisms which need ncit be discussed here.

The fuel cell stack 2 electrical output lines 10 are also coupled to a load circuit 12 which is switchably coupled to the fuel cell stack 2 by way of switch 14. The load circuit 12 may be generally used to periodically receive a discharge current from the fuel cell stack during a special energy dissipation operation used to condition the fuel cell stack, such as the air stall operations or stack pulses mentioned above.

The fuel cell stack 2 may also include a heater apparatus integrated therewith (not shown) which can be used to preheat the fuel cell stack, e.g. for defrost or for optimising fuel cell performance. The heater apparatus may be configured to be operated either by a supporting battery (not shown) or by power from the fuel cell stack output itself, typically via a DC/DC converter coupled to the output of the fuel cell stack. Such stack heaters may routinely be provided for certain types of stack, such as those used in automotive applications where cold/freezing start-up conditions may be routinely accommodated.

Also provided within the fuel cell system 1 is a protection circuit 16 coupled to the load circuit 12 which is configured to protect the load circuit 12 in a manner to be described below.

FIG. 2 illustrates an exemplary ‘stack pulse’ or ‘fan pulse’, or air stall operation 20. In normal operation of the fuel cell stack 1, hydrogen or another fuel is being supplied to flow channels in the anodes of the fuel cell stack 2, and air flow is passing through flow channels in the cathodes of the fuel cell stack.

A fan pulse or air stall operation is initiated by the controller 8 shutting off the fan 6 and closing the louvre 7 (step 21). The shut-off process may take several seconds, e.g. 5 seconds to close the louvre, and thus a typical procedure may allow 10 seconds to complete the air stall giving time for air flow in the cathode flow path to cease and oxygen starvation of the stack to commence. The fuel cell stack is then discharged during an energy dissipation phase (steps 22 to 26). If the fuel cell stack 2 is provided with integral heater apparatus, this may be used initially (step 22) to commence discharging of the stack 2. This reduces the energy dissipation that must be effected by the load circuit 12 resistors. After energy dissipation by the heaters, the special discharge load circuit 12 is switched in (step 23) to complete the discharge of the fuel cell stack 2. If there is no heater apparatus in the stack, or it is not appropriate to use it, the load circuit 12 may be configured to provide for the full discharge of the stack, omitting step 22.

Commencing the energy discharge phase of steps 22-23 too quickly (i.e. before the air flow through the stack has fully stalled} would increase the amount of energy that must be dissipated through the load circuit 12 and/or heaters. Thus, the system controller 8 is preferably configured to shut off air flow through the fuel cell stack prior to switching to energy dissipation in the load circuit so as to allow the fuel cells to reach an oxygen starved condition prior to commencement of the energy dissipation phase. 30 The amount of energy to be dissipated during an air stall, or stack energy dissipation phase, can be readily determined by experimentation for different stack designs, for different resistive and/or active loads.

For example, the table below illustrates typical values of energy dissipation through the load circuit 12 for different resistor values and load currents. Also given are the energy dissipation times, the average power values and the peak power values for the different values of resistor used in the load circuit.

| | Active load Current/Resistor Value | | | | | |
|---|---|---|---|---|---|---|
| | 20 A | 30 A | 40 A | 1 ohm | 2.35 ohm | 4.7 ohm |
| Energy dissipated kJ | 1.3 | 0.95 | 0.82 | 0.97 | 1.3 | 1.651 |
| Dissipation time ms | 1320 | 855 | 612 | 993 | 1250 | 3870 |
| Avg. Power (W) | 984 | 1111 | 1339 | 976 | 1040 | 426 |
| Peak Power (W) | 1200 | 2200 | 2300 | 2000 | 1800 | 600 |

It can be seen that the energy to be dissipated from a stack varies with the load circuit resistance. Lower resistance and higher discharge current (e.g. 1 ohm resistance or 40 A discharge current) actually results in lower energy dissipation requirement (e.g. 0.97 or 0.82 kJ respectively), and beneficially shortens the energy dissipation time.

However, it can be seen that the peak power rating for such low value resistors suggests very high rated resistors would be required, e.g. bulky wire wound resistors. Ideally the load circuit resistors are incorporated into the control module for the fuel cell system and bulky wire wound resistors that can meet the peak power specification may be too large. Smaller and low profile power resistors are preferred, such as the thick film variety.

Typically such resistors have a continuous power rating and a short term overload rating. It has been shown that the higher the current drawn, the lower the energy to be dissipated. In the present context, the application of periodic stack conditioning using a high discharge current for a short period during an air stall operation, the quantity of energy to be dissipated from the fuel cell stack can be quite precisely characterised and the frequency of the air stall operations can be managed. Thus it is possible to fairly precisely characterise the short time overload conditions that will prevail and the total energy dissipation requirements within a given time period.

Thus, the load circuit 12 resistors can be under-rated and overloaded for the duration of the air stall period, provided that the maximum energy deliverable by the fuel cell stack during the air stall condition can be guaranteed. The maximum electrical energy deliverable by a fuel cell or fuel cell stack under air stall conditions may be defined herein as the total air stall energy. This may correspond to the maximum electrical energy deliverable by the fuel cell or fuel cell stack before all residual oxidant within the cathode flow paths is consumed.

A typical short time overload specification for a thin film power resistor selected for this application might be 1.5 times the continuous power rating for, e.g. 10 seconds. Thus, the resistor may generally be selected for an air stall period and total energy dissipation/maximum current requirement which fits within the short time overload specification of the resistor rather than the nominal continuous power rating. This choice may need to take into account a safe current maximum for other components of the system such as a stack fuse.

One feature of air stall/fan pulse operations is that exceptional conditions may occasionally prevail which could significantly vary the amount of energy that a fuel cell stack is capable of delivering during an air stall condition. A fuel cell stack needs very little air flow to produce a significant amount of energy. If the system louvers do not seal properly and/or if the stack is pulsed under ram air (e.g. increased air pressure from the movement of a vehicle in which the stack is disposed) forcing its way past any such air flow control device, the amount of energy that will pass into the discharge resistor may be significantly higher than even the short time overload capacity of the discharge resistor. Therefore, protecting the discharge resistors against excessive energy pulses arising from a ‘failed’ fan pulse/air stall operation is proposed.

Protecting the load circuit resistor(s) against an over-power condition only may not be sufficient. The power is an important figure to be assessed but it should be linked to the overload duration. Heat in the resistor is created by power and time (energy), not power only. The overload capacity depends on the ability of the resistor to distribute the resulted heat over the discharge duration. A protection solution described here is based on limiting the amount of energy going to the discharge resistors.

With further reference to FIG. 2, a protection solution includes involves monitoring, by the protection circuit 16, the energy that is being dissipated into the discharge load circuit 12 (step 24) and testing to see if a maximum short term energy dissipation threshold is reached (step 25). If the energy threshold is reached, the protection circuit 16 is operable to abort the fan pulse operation (step 26), and to resume normal fuel cell system operation (step 27). The system may then loop back ready for the next fair stall/fan pulse operation.

FIG. 3 shows a functional block diagram of a protection circuit 16 for the load circuit 12. The energy dissipated in the load circuit resistor(s) is proportional to ∫V² dt. The protection circuit 16 comprises an input line 30 coupled to receive the stack voltage or the voltage across the resistor (e.g. on lines 17 in FIG. 1). Module 31 determines the square of the input voltage (or at least a function thereof) and module 32 integrates this function over time, to determine a cumulative energy dissipation level in the load circuit resistor during an energy dissipation phase. The calculated energy 33 is then compared, by comparator 34, to a threshold value 35. If the threshold value is reached, an output 36 of the comparator 34 is used to trigger a trip switch 37 to abort the energy dissipation phase. Aborting the energy dissipation phase may comprise automatically opening the switch 14.

This may effectively terminate the discharge step 23 of the air stall operation at step 26.

The protection circuit 16 can be configured in a number of different ways. For example, it will be recognised that power can be calculated not just be V²/R, but alternatively by I²R or V*I. Thus, the arrangement of FIG. 3 could be adapted to receive a signal representative of current through the load circuit 12 on input line 30, and module 31 may determine a square of the input current (or at least a function thereof, and module 32 then integrates this function over time, to determine the cumulative energy dissipation level in the load circuit resistor during an energy dissipation phase. The threshold value 35 is set according to requirements.

FIG. 4 shows a functional block diagram of a still further arrangement of protection circuit. In this arrangement, the energy dissipated in the load circuit resistor(s) is proportional to V*I dt. The protection circuit 16 comprises a first input line 40 coupled to receive the stack voltage or the voltage across the resistor (e.g. on lines 17 in FIG. 1), 30 and a second input line 41 coupled to receive a measure of the current flowing through the resistor of the load circuit. Module 42 determines the power based on the V*I product and module 43 calculates power integrated over time, to determine a cumulative energy dissipation level in the load circuit resistor during the energy dissipation phase. The calculated energy 44 is then compared, by comparator 45, to a threshold value 46. If the threshold value is reached, an output 47 of the comparator 45 is used to trigger a trip switch 48 to abort the energy dissipation phase. Aborting the energy dissipation phase may comprise automatically opening the switch 14.

The threshold value 35 or 46 may be set to any suitable value suggested by the short time overload capability of the load circuit discharge resistor being monitored. A suitable margin for error may be incorporated, e.g. by setting the threshold somewhat lower than short time overload capacity of the resistor for the time periods expected for the air stall operation.

The controller 8 may be configured to control the air stall and discharge operations in a number of ways. In a general aspect, the system controller 8 may be configured to periodically initiate an energy dissipation phase by switching the load circuit across one or more cells in a fuel cell stack or across the entire stack, or across one or more cells in a parallel connected array of fuel cells.

Fuel cell conditioning events (e.g. stack pulsing, fan pulsing etc) may be triggered at regular time intervals or at intervals determined according to prevailing operating conditions of the fuel cell system. The expression “periodically” is intended to cover both regular (fixed period) and variable period e.g. “on demand” (i.e. not necessarily having a fixed period). The fuel cell conditioning events may generally be configured to have a fixed duration unless aborted according to the mechanisms described above.

In the event of an abort of an energy dissipation phase through the load circuit 12, triggered by the protection circuit 16, the controller 8 may be configured to inhibit the initiation of a further energy dissipation phase through the load circuit until at least a predetermined time period has elapsed to enable a cool down of transiently overloaded resistors.

In the event of an abort of an energy dissipation phase through the load circuit 12, triggered by the protection circuit 16, the controller 8 may be configured to limit the duration of a subsequent energy dissipation phase to a duration shorter than a normal duration to ensure that a subsequent phase does not overheat the resistor.

In the event of an abort of an energy dissipation phase through the load circuit 12, triggered by the protection circuit 16, the controller 8 may be configured to initiate one or more retries of the conditioning operation, e.g. following reopening and reclosing the air stall mechanism 7. The number of retries may be a predetermined fixed number, or may be adapted according to the energy dissipation levels detected by the protection circuit.

The load circuit 12 may comprise one or more resistors connected in series or in parallel. These resistors could be protected all together by one protection circuit 16, or multiple protection circuits 16 could be by deployed to each monitor one or more resistors. An abort event could be triggered by the cumulative energy level reaching a threshold for any one resistor or group of resistors.

The fuel cell system 1 may comprise a single fuel cell in place of the stack 2, or an array of in series/parallel connected fuel cells in place of the stack 2.

The protection circuit 16 could be implemented in application specific hardware/circuitry or could be implemented as one or more software modules in programmable logic circuitry or in a general purpose programmable computer system, or in a combination thereof.

The load circuit 12 and protection circuit 16 discussed above may be used in conjunction with energy dissipation during a fuel cell conditioning operation performed by another available load device, such as system heaters as mentioned earlier or any other suitably available active load. This may further cut the performance specification of resistors required for the load device 12.

Existing fuel cell system heaters (such as recirculation heaters used for cold start operation) can be utilised to reduce the amount of energy dissipated into the discharge resistors and therefore reduce further the size and the cost of the discharge resistors. The heaters can be switched on at the start of the fan pulse operation (step 27 in FIG. 2). The heaters may be powered from the fuel cell stack through a DC/DC converter. The input range of the DC/DC converter may therefore be extended to operate where the stack voltage drops significantly as a result of current drawn by the heaters, e.g. to operate from 35 V to 75 V for a nominal stack voltage of 80 V. Therefore, the heaters can be used to bring the stack voltage down to 35 V. A lot of energy can be dissipated into the heaters before the stack voltage reaches 35 V.

Examples of the amount of energy which may first be dissipated by the heaters prior to the load circuit 12 being switched in are shown in the table below.

| | Current/Resistor | | | | | |
|---|---|---|---|---|---|---|
| | 20 A | 30 A | 40 A | 1 ohm | 2.35 ohm | 4.7 ohm |
| | Heater ON time (s) | | | | | |
| | 20 | | | | | |
| Energy dissipated J | 48 | 43 | 33.4 | 74.6 | NA | NA |
| Dissipation time ms | 138 | 70 | 45 | 259 | NA | NA |
| Avg. Power (W) | 347.8 | 614 | 742.2 | 288 | NA | NA |
| | Heather ON time (s) | | | | | |
| | 10 | | | | | |
| Energy dissipated J | 278.2 | 227 | 174.5 | 282.1 | 445.13 | 593.75 |
| Dissipation time ms | 451.5 | 237.9 | 169.5 | 474.4 | 1066.7 | 1813.33 |
| Avg. Power (W) | 616.6 | 954.2 | 1029 | 594.6 | 417.6 | 327.49 |
| | Heather ON time (s) | | | | | |
| | 5 | | | | | |
| Energy dissipated J | 680.7 | 533.2 | 421.8 | 597.3 | 834.55 | 1060.33 |
| Dissipation time ms | 923.46 | 523.8 | 370.3 | 707.766 | 1566.66 | 1493.33 |
| Avg. Power (W) | 737 | 1017 | 1139 | 844 | 532.9 | 710 |

It can be seen that switching the heaters on for 5 seconds can reduce the amount of energy required to be dissipated by the load circuit resistor by 40% for 1 Ohm resistor.

A prototype system has been tested using simulated air flow representative of a moving vehicle condition in which the fuel cell is situated, by using a fan array. Fuel cell system operation was interrupted for a fan pulse procedure and energy from the fuel cell stack was dissipated firstly in recirculation heaters for 21 seconds and then to selected load circuit 800 W power resistors. The protection circuit was set to trip the power switches when the energy exceeds 700 Joules. Load current, load voltage and the output of the integrator circuit were measured using a DSO to calculate the actual energy dissipated to the load resistors. Temperature of the load resistors, speed of air from the fan array, and energy measured across the load resistors was logged.

The protection circuit was tested using different ram air speeds from the fan array. With no ram air, the system fan pulsed successfully. With a louver sealing insufficient to prevent ram air from penetrating the cathode air flow path of the fuel cell stack 2, the protection circuit 16 was operative to isolate the load circuit resistors after the energy threshold was reached.

In a test system, a full air-stall stack energy was about 1000 J. With a minimum stack output voltage of 80 V and by using system heaters during the first phase of the air stall operation, it was possible to reduce the amount of energy to be dissipated by the load circuit resistors to 75 J. One selected resistor type is able to accommodate the worst case of 1000 J for a period of 1 second, and the 75 J required when system heaters are deployed for a period of 300 ms. In an exemplary arrangement, the protection circuit 16 was configured to protect the load circuit resistors against an energy dissipation event exceeding 700 J.

Various modifications can be envisaged in the apparatus and methods described. The protection circuit 16 preferably senses the voltage across a resistor in the load circuit 12 continuously from the start of an energy dissipation phase during which stack current is passed into the resistor. In an alternative arrangement, the monitoring of the cumulative energy dissipation level could be performed on a sampling basis, e.g. discontinuously, assuming that the sampling intervals are sufficiently frequent during an energy dissipation phase to ensure that an adequately accurate estimate of energy dissipated as a function of time in the resistor is provided.

In another arrangement, the step of aborting an energy dissipation phase when a load circuit (e.g. resistor) has reached a threshold cumulative energy dissipation level may comprise switching the energy dissipation phase to a different available load circuit (e.g. a different resistor) and recommencing or continuing an air stall operation therewith.

In tests, it has been found that relying on transient overloading of resistors, with an appropriate protection circuit as described above, enables a reduction in resistor size to approximately one-quarter or one-fifth size. This can represent a considerable saving in cost and size of the load circuit or load circuits.

In another general aspect described here, it can recognised that if correct operation of an air stall operation can be relied upon, a well characterised air stall energy will need to be dissipated in the load circuit. It may therefore be acceptable to select one or more resistors in the load circuit according to the total amount of energy deliverable by the fuel cell during an air stall operation. In this respect, the resistor or resistors of the load circuit is selected with a short term overload rating and a continuous rating such that it operates within its short term overload rating but outside its continuous power rating when dissipating the full fuel cell air stall energy. In this way, in view of the transient nature of the stack conditioning operation, substantially smaller resistors can be selected.

Other embodiments are intentionally within the scope of the accompanying claims.

1. A fuel cell system comprising:
an electrochemical fuel cell for generating electrical power;
a load circuit switchably coupled to the fuel cell for periodically receiving a discharge current from the fuel cell during an energy dissipation phase;
a protection circuit coupled to the load circuit, the protection circuit configured to monitor a cumulative energy dissipation level during an energy dissipation phase and to abort an energy dissipation phase if the cumulative energy level reaches a predetermined threshold.

2. The fuel cell system of claim 1 in which the load circuit comprises a resistor.

3. The fuel cell system of claim 1 in which the protection circuit comprises a voltage sensor and a module configured to integrate a function of the sensed voltage during an energy dissipation phase, the protection circuit further configured to abort the energy dissipation phase if the integration reaches said predetermined threshold.

4. The fuel cell system of claim 3 in which the voltage sensor is configured to sense a voltage across a resistor of the load circuit.

5. The fuel cell system of claim 1 in which the protection circuit comprises a current sensor and a module configured to integrate a function of the sensed current during an energy dissipation phase, the protection circuit further configured to abort the energy dissipation phase if the integration reaches said predetermined threshold.

6. The fuel cell system of claim 5 in which the current sensor is configured to sense a current passing through a resistor of the load circuit.

7. The fuel cell system of claim 1 in which the protection circuit comprises a voltage sensor and a current sensor, and a module configured to determine said cumulative energy dissipation level in the load circuit from the sensed voltage and current during an energy dissipation phase.

8. The fuel cell system of claim 7 in which the voltage sensor is configured to sense a voltage across a resistor of the load circuit and in which the current sensor is configured to sense a current passing through the resistor of the load circuit.

9. The fuel cell system of claim 1 further including a system controller configured to periodically initiate an energy dissipation phase by switching the load circuit across one or more fuel cells in the fuel cell system.

10. The fuel cell system of claim 9 in which the system controller is further configured to periodically shut off air flow through the one or more fuel cells during the energy dissipation phase and to restore air flow after the energy dissipation phase.

11. The fuel cell system of claim 10 in which the system controller is configured to shut off air flow through the one or more fuel cells prior to the energy dissipation phase so as to allow the one or more fuel cells to reach an oxygen-starved condition prior to commencement of the energy dissipation phase.

12. The fuel cell system of claim 9 in which the system controller is configured to inhibit initiation of a further energy dissipation phase for a predetermined period of time in the event of an aborted energy dissipation phase.

13. The fuel cell system of claim 9 in which the system controller is configured to restrict the duration of a subsequent energy dissipation phase in the event of an aborted energy dissipation phase.

14. The fuel cell system of claim 1 in which the electrochemical fuel cell comprises a stack of series-connected fuel cells.

15. The fuel cell system of claim 1 in which the electrochemical fuel cell comprises an array of parallel connected fuel cells.

16. A protected electrical load device, the load device comprising:
a load circuit for switchably coupling to a power source for periodically receiving a discharge current from the power source during an energy dissipation phase;
a protection circuit coupled to the load circuit, the protection circuit configured to monitor a cumulative energy dissipation level in the load circuit during an energy dissipation phase and to abort an energy dissipation phase if the cumulative energy level reaches a predetermined threshold.

17. A method of operating a fuel cell system, comprising:
generating electrical power in an electrochemical fuel cell;
periodically passing a discharge current from the fuel cell into a load circuit during an energy dissipation phase;
during the energy dissipation phase, monitoring cumulative energy dissipated in the load circuit; and
aborting the energy dissipation phase if the cumulative energy level exceeds a predetermined threshold.
